(19) United States
(12) Patent Application Publication
(10) Pub. No.: US 2017/0222453 A1
(43) Pub. Date: Aug. 3, 2017

(54) DEVICE, APPARATUS AND METHOD FOR SUPPORTING MULTI-BATTERY QUICK CHARGE

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Haihua WANG, Tianjin (CN); Yi ZHENG, Tianjin (CN)

(21) Appl. No.: 15/250,554

(22) Filed: Aug. 29, 2016

Related U.S. Application Data
(63) Continuation of application No. PCT/CN2016/088457, filed on Jul. 4, 2016.

(30) Foreign Application Priority Data
Jan. 30, 2016 (CN) 201610065496.X

(51) Int. Cl. H02J 7/00

(52) U.S. Cl. CPC H02J 7/0013; H02J 7/0081

(57) ABSTRACT

A device, an apparatus and a method for supporting multi-battery quick charge are disclosed. The apparatus includes an adapter, a processor, a charge chip and a voltage adjustment circuit. The adapter includes a DP port, a DM port, a charge voltage output port and a ground port. A first adjustment port and a second adjustment port are disposed on the processor. The voltage adjustment circuit includes a first adjustment branch and a second adjustment branch. The charge voltage output port is connected to the charge chip, the first adjustment branch is respectively connected to the DP port and the first adjustment port, and the second adjustment branch is respectively connected to the DM port and the second adjustment port. By means of the device, apparatus and method for supporting multi-battery quick charge according to embodiments of the present disclosure, the problem that currently quick charge for electronic devices that use multiple batteries cannot be performed is resolved.

### CROSS REFERENCE TO RELATED APPLICATIONS

This application is a continuation of International Application No. PCT/CN2016/088457 filed on Jul. 4, 2016, which is based upon and claims priority to Chinese Patent Application No. 201610065496, filed before Chinese Patent Office on Jan. 30, 2016 and entitled “DEVICE, APPARATUS AND METHOD FOR SUPPORTING MULTI-BATTERY QUICK CHARGE”, the entire contents of which are incorporated herein by reference.

### TECHNICAL FIELD

The present disclosure relates to the field of quick charge technologies, and more particularly to a device, an apparatus and a method for supporting multi-battery quick charge.

### BACKGROUND

With the rapid development of the electronic product industry, portable electronic devices have been more frequently used by people. By using mobile phones as an example, experience of mobile phones is affected by multiple factors, one of which is the energy problem. Energy for a mobile phone comes from a battery, and battery performance directly affects a use time of the mobile phone. In addition to the battery performance, a use manner of the mobile phone also affects the influence on experience of the mobile phone from the battery performance of the mobile phone.

As time changes, large-screen smart phones are very popular nowadays, and large-screen smart phones consumes electric power in a particularly significant manner. People grow increasingly dependent on mobile phones. This imposes an extremely demanding requirement for battery energy of mobile phones. Meanwhile, mobile phones are designed to be lighter and thinner, fast battery replacement is not supported, and energy input completely relies on a charge port and a data port.

However, instead of increasing in size, charge ports of mobile phones are becoming increasingly miniaturized. As electrical contact areas of ports decrease, contact resistance increases and heat dissipation capability decreases consequently, which reduces a current that is allowed to pass through the ports and increases difficulty in charging mobile phones.

At present, Qualcomm's QC2.0 high voltage dedicated charge port (HVDCP) can desirably resolve a quick charge problem of a single battery; however, QC2.0 does not support multi-battery quick charge. In this case, quick charge for some electronic devices (for example, miniature projectors) that use multiple batteries is not ensured, which constrains disclosure of these electronic devices.

### SUMMARY

The present disclosure provides a device, an apparatus and a method for supporting multi-battery quick charge, so as to resolve a problem that currently quick charge for electronic devices that use multiple batteries cannot be performed.

An embodiment of the present disclosure provides a device for supporting multi-battery quick charge, where the device includes a processor, a charge chip and a voltage adjustment circuit, where

a first adjustment port and a second adjustment port are disposed on the processor;

the voltage adjustment circuit includes a first adjustment branch and a second adjustment branch; and

an end of the first adjustment branch is connected to the first adjustment port, and an end of the second adjustment branch is connected to the second adjustment port.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram illustrating an apparatus for supporting multi-battery quick charge according to some embodiments of the present disclosure; and

FIG. 2 is a flowchart illustrating a method for supporting multi-battery quick charge according to some embodiments of the present disclosure.

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

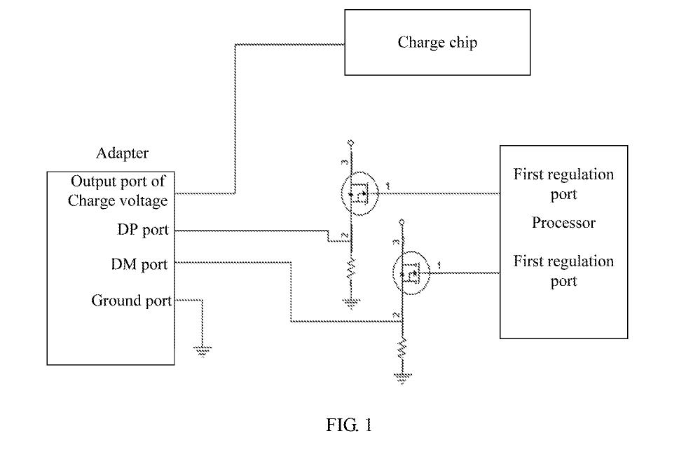

FIG. 1 is a schematic structural diagram illustrating an apparatus for supporting multi-battery quick charge according to an embodiment of the present disclosure. As illustrated in FIG. 1, the apparatus for quick charge includes an adapter, a processor, a charge chip and a voltage adjustment circuit. The adapter includes a DP port, a DM port, a charge voltage output port and a ground port. A first adjustment port and a second adjustment port are disposed on the processor. The voltage adjustment circuit includes a first adjustment branch and a second adjustment branch. The charge voltage output port is connected to the charge chip, the first adjustment branch is respectively connected to the DP port and the first adjustment port, and the second adjustment branch is respectively connected to the DM port and the second adjustment port.

The first adjustment port and the first adjustment port are both general-purpose input output (GPIO).

It should be noted that the apparatus for supporting multi-battery quick charge may include two parts, where one part is an adapter, and the other part is a device for supporting multi-battery quick charge. The device may include a processor, a charge chip and a voltage adjustment circuit. A first adjustment port and a second adjustment port are disposed on the processor. The voltage adjustment circuit includes a first adjustment branch and a second adjustment branch. An end of the first adjustment branch is connected to the first adjustment port, and an end of the second adjustment branch is connected to the second adjustment port.

In an actual disclosure scenario, the adapter and the device for quick charge may be separately used. When the device for quick charge needs to be charged, the adapter may be connected to the device for quick charge by using a type-C interface. Certainly, the adapter and the device for quick charge may also be used in combination and produced as a set of products, which is not limited in the present disclosure.

In this embodiment of the present disclosure, the charge chip is a normal chip for supporting multi-battery charge, and the voltage adjustment circuit, the adapter and the processor are disposed, so that a charge voltage of the normal chip can be adjusted, thereby satisfying the demands of quick charge. Specifically, an output voltage of the charge voltage output port may be coordinately determined by a voltage of the DM port and a voltage of the DP port. Specifically, a relationship between the output voltage of the charge voltage output port and the voltage of the DM port and the voltage of the DP port may be shown in Table 1:

TABLE 1
Schematic table of voltages of a charge voltage output port

| | | Charge voltage |
|---|---|---|
| DP port | DM port | output port |
| 0.6 V | 0.6 V | 12 V |
| 3.3 V | 0.6 V | 9 V |
| 3.3 V | 3.3 V | 20 V |
| 0.6 V | GND | 5 V |

As can be seen from Table 1,when the voltage of the DP port is 0.6 V and the voltage of the DM port is 0.6 V, a voltage of the charge voltage output port is 12 V;

when the voltage of the DP port is 3.3 V and the voltage of the DM port is 0.6 V, the voltage of the charge voltage output port is 9 V;

when the voltage of the DP port is 3.3 V and the voltage of the DM port is 3.3 V the voltage of the charge voltage output port is 20 V; and

when the voltage of the DP port is 0.6 V and the DM port is grounded, the voltage of the charge voltage output port is 5 V.

As can be seen, by changing the voltages of the DP port and the DM port, the voltage of the DP port and the voltage of the DM port may meet a preset corresponding relationship, so that the voltage of the charge voltage output port may be further determined. In this way, the voltage of the charge voltage output port may change, according to a requirement, among four voltage values: 5 V, 9 V, 12 V and 20 V. Because a charge power is a product of multiplying a charge voltage and a charge current, in a case in which the charge current is relatively small, the charge power may be increased by increasing the charge voltage, so that quick charge may be implemented.

In this embodiment of the present disclosure, the first adjustment branch and the second adjustment branch may have the same circuit structure. By using the first adjustment branch as an example, the first adjustment branch may be formed of a MOSFET and a resistor that are connected in series, where a first port of the MOSFET may be connected to the first adjustment port on the processor, a second port of the MOSFET may be connected to a resistor whose resistance value is 10 kohms, and a third port of the MOSFET may be connected to a direct-current voltage of 0.6 V. In this way, the processor may deliver a boost or buck driving signal to the MOSFET by using the first adjustment port, so that an output current of the second port of the MOSFET may be controlled. In this way, a value of a voltage applied on the DP port may be changed.

A process of changing a value of the voltage of the DM port is similar to that of the DP port, which is therefore no longer described herein.

It should be noted that, 0.6 V and 3.3 V that are specified in Table 1 may be both regarded as nominal values of voltages. In an actual disclosure scenario, a voltage whose voltage value ranges from 0.325 V to 2 V may be regarded as 0.6 V, and a voltage whose voltage value is greater than 2 V may be regarded as 3.3 V. In this way, once the voltage of the DM port and the voltage of the DP port satisfy the foregoing voltage range, the voltage of the charge voltage output port may be limited.

Below, in this embodiment of the present disclosure, a working principle of the apparatus for quick charge is described.

A battery charge circuit inside an electronic device may include, according to functions, two parts, where one is a measurement and feedback control part, and the other is a voltage-current conversion part. In an actual disclosure, the two parts may usually be integrated in one module.

The measurement and feedback control part is responsible for monitoring key parameters of battery charge (for example, a battery charge current, a battery current voltage and a battery temperature), and according to a preset battery charge algorithm, adjusts parameters such as a charge current or turns off charge. By using a mobile phone as an example, a measurement and feedback control part of a charge circuit of a mobile phone may usually adjust some parameters by using software programming. Even for some mobile phones, most of the functions of measurement and feedback control parts for charge are implemented by using software. In most of the mobile phones, control algorithms for charging lithium batteries are based on a constant-current constant-voltage process or a variant thereof. A constant-current constant-voltage charge process may be generally understood as: first, when a battery is lower than a charge limit voltage (4.2 V for earlier mobile phones, and nowadays it is usually 4.35 V) of the battery, one constant current is used to charge the battery.

A ratio (or referred to as a charge current rate) of the magnitude of this constant current to a battery capacity is closely related to a charge speed of a battery for a mobile phone. To improve the charge speed for the mobile phone, one effective measure is to improve a charge current rate. However, a battery of a mobile phone has limited tolerance for a charge current rate, and an excessively large charge current rate causes increased cyclic attenuation of the battery of the mobile phone, or even may cause a battery safety problem. Currently, batteries of most of the mobile phones may tolerate 0.5 time to 1 time of the charge current rate. For example, for a battery of 3000 mAh of a mobile phone, the 0.5 time to 1 time of the charge current rate corresponds to a charge current of 1500 mA to 3000 mA. By optimizing a battery structure and formula, a battery can tolerate a larger charge current rate.

After the battery is charged by using a constant current and the charge limit voltage of the battery is reached, the charge current is gradually reduced to keep the charge limit voltage unchanged. Because for a lithium ion battery, a voltage increases long with the fullness of the battery, when a charge current increases, the voltage of the battery also increases. Therefore, in a case in which the fullness keeps increasing, the voltage of the battery may be maintained constant by reducing the charge current, that is, a constant-voltage process. When the charge current is reduced to a predetermined value, the charge current is turned off, and charge is completed.

A mobile phone is still used as an example. A circuit function of the voltage-current conversion part is to convert, under the control of the measurement and feedback control part, electric energy obtained from a charge port of the mobile phone into a charge current of a battery. Because a voltage input in the charge port of the mobile phone is usually a voltage such as 5 V and 9 V and does not match a battery voltage (3.0 V to 4.35 V, which changes with a power level and the charge current), conversion is required. That is, a quick charge program preset at the measurement and feedback control part determines a charge voltage and the charge current of the battery of the mobile phone. As long as an input voltage, being a little higher or a little lower, is still within a range allowed by the voltage-current conversion part, the input voltage is converted by the voltage-current conversion part into a value set by the program.

Circuit types of the voltage-current conversion part may usually include the following two types:

i. Linear Conversion Circuit.

The linear conversion circuit is substantially one variable resistor regulated by the measurement and feedback control part. A resistor is used to consume, in a heat generating manner, a part, higher than a battery voltage, of a voltage of a charger. For example, a voltage input in the charge port is 5 V, a battery voltage is 3.7 V, and a charge current of 1000 mA is required. In this case, a resistance value of the variable resistor is made to be 1.3 ohms. As long as a resistance value of the variable resistor keeps changing, an entire constant-current constant-voltage process can be accomplished. As can be seen from Kirchhoff's laws, an input current of this circuit is equal to an output current. Therefore, when an input voltage is increased, for this circuit, only more input power is consumed by using a resistor, and a charge power of the battery does not increase. In addition, when the charge current is excessively high, a heat generation power is also large. Therefore, such a circuit is not suitable for charging current mobile phones that require a large current for charge and have limited space.

ii. Switch Conversion Circuit.

The switch conversion circuit may reduce an input voltage to a battery voltage by using a high-speed switch (which is usually implemented by using a MOSFET) and an inductor, and a charge current is controlled under the regulation of the measurement and feedback control part. A relationship between an output current and voltage and an input current and voltage of such a circuit may be obtained by using energy conservation law: input voltage×input current×efficiency=output voltage×output current. In current new-type mobile phones, the efficiency may reach above 90%. In this embodiment of the present disclosure, by using such a switch conversion circuit, an input high voltage and relatively low current can be converted into a battery voltage and a relatively large charge current.

For example, a battery voltage is 3.7 V, and a battery charge current of 2 A is required. A charge circuit has efficiency of 90%, and a voltage drop caused by other resistors is omitted. A voltage at an input port is 9.0 V, a current that passes through the input port needs to be: 3.7 V×2.0 A/90%/9.0 V=0.91 A. As can be seen, in this embodiment of the present disclosure, a current at an input port can actually be effectively reduced by increasing an input voltage.

In this embodiment of the present disclosure, when a connection is established between the apparatus for supporting multi-battery quick charge and the electronic device, the apparatus for quick charge may establish a handshake process with the electronic device. An Android phone is used as an example, and the handshake process may be as follows:

When the apparatus for quick charge is connected to a mobile phone by using a data cable, the apparatus for quick charge short-circuits the DM port and the DP port by default. In this case, a charger type detected by a mobile phone end is a dedicated charge port (DCP) mode. In this case, the voltage of the charge voltage output port is 5 V, and the mobile phone may perform normal charge according to a default speed. If the mobile phone turns on a quick charge mode, an hvdcp process in Android user space is started, so that a connection may be established to the processor in the apparatus for quick charge, and the first adjustment port on the processor is used to send a boost signal to the first port of the MOSFET in the first adjustment branch. In this way, a voltage of 0.325 V may start to be applied on the DP port.

When this voltage is kept for 1.25 s, the apparatus for quick charge turns off a short-circuited state between the DP port and the DM port. In this case, a voltage on the DM port will decrease. When the mobile phone end detects that the voltage on the DM port decreases, the hvdcp process reads a value of /sys/class/power_supply/usb/voltage_max inside the mobile phone. If the value is 9000000 (mV), the mobile phone may continue to perform instruction transmission with the processor in the apparatus for quick charge, so that a voltage on the DP port may be set to 3.3 V and the voltage on the DM port may be set to 0.6 V. In this way, the output voltage of the charge voltage output port may be 9 V. Certainly, as the value of voltage_max changes, the voltages on the DP port and the DM port change accordingly, so that it may be implemented that the voltages change, according to a requirement, among four voltage values: 5 V, 9 V, 12 V and 20 V.

As can be seen, in this embodiment of the present disclosure, on the basis of a normal charge chip for supporting multi-battery charge, an adapter, a voltage adjustment circuit and a processor are added, so that a voltage of a DP port and a voltage of a DM port on the adapter can be adjusted according to a voltage required for quick charge, and a voltage of a charge voltage output port can be coordinately limited by using the voltage of the DP port and the voltage of the DM port, to enable a charge voltage of an electronic device to change, according to a requirement, among four voltage values: 5 V, 9 V, 12 V and 20 V, thereby satisfying a requirement of multi-battery quick charge.

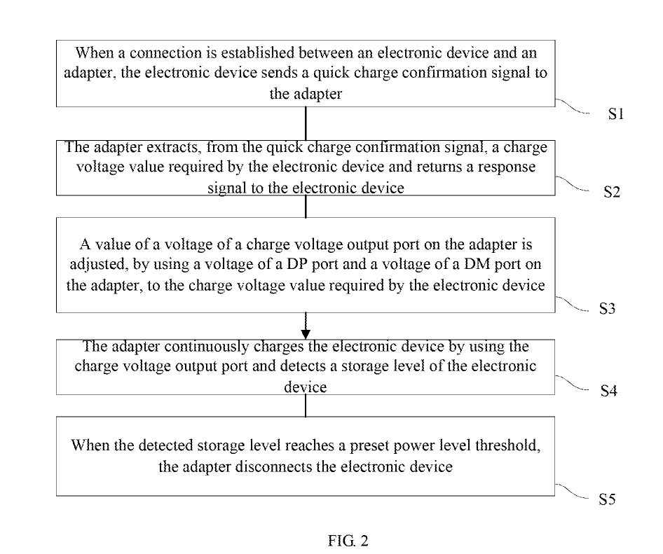

An embodiment of the present disclosure further provides a method for supporting multi-battery quick charge. FIG. 2 is a flowchart illustrating a method for supporting multi-battery quick charge according to an embodiment of the present disclosure. Although the procedure described below includes multiple operations that appear in a specific order, it should be clearly understood that these procedures may include more or less operations, and these operations may be executed in an order or executed in parallel (for example, use a parallel processor or a multi-thread environment). As illustrated in FIG. 2, the method may include:

S1: When a connection is established between an electronic device and an adapter, the electronic device sends a quick charge confirmation signal to the adapter.

S2: The adapter extracts, from the quick charge confirmation signal, a charge voltage value required by the electronic device and returns a response signal to the electronic device.

S3: A value of a voltage of a charge voltage output port on the adapter is adjusted, by using a voltage of a DP port and a voltage of a DM port on the adapter, to the charge voltage value required by the electronic device.

S4: The adapter continuously charges the electronic device by using the charge voltage output port and detects a storage level of the electronic device.

S5: When the detected storage level reaches a preset power level threshold, the adapter disconnects the electronic device.

In a specific embodiment of the present disclosure, that a value of a voltage of a charge voltage output port on the adapter is adjusted, by using a voltage of a DP port and a voltage of a DM port on the adapter, to the charge voltage value required by the electronic device specifically includes:

delivering, by a processor, according to the charge voltage value required by the electronic device, a first voltage adjustment instruction to a first adjustment branch connected to the DP port, to make a value of the voltage of the DP port match the charge voltage value of the electronic device; and

delivering, by a processor according to the charge voltage value required by the electronic device, a second voltage adjustment instruction to a second adjustment branch connected to the DM port, to make a value of the voltage of the DM port match the charge voltage value of the electronic device.

In another specific embodiment of the present disclosure, the processor delivers the first voltage adjustment instruction to a MOSFET in the first adjustment branch by using a first adjustment port and delivers the second voltage adjustment instruction to a MOSFET in the second adjustment branch by using a second adjustment port.

In another Specific embodiment of the present disclosure, that a value of a voltage of a charge voltage output port on the adapter is adjusted, by using a voltage of a DP port and a voltage of a DM port on the adapter, to the charge voltage value required by the electronic device specifically includes:

when the voltage of the DP port is 0.6 V and the voltage of the DM port is 0.6 V, adjusting the voltage of the charge voltage output port to 12 V;

when the voltage of the DP port is 3.3 V and the voltage of the DM port is 0.6 V, adjusting the voltage of the charge voltage output port to 9 V;

when the voltage of the DP port is 3.3 V and the voltage of the DM port is 3.3 V, adjusting the voltage of the charge voltage output port to 20 V; and

when the voltage of the DP port is 0.6 V and the DM port is grounded, adjusting the voltage of the charge voltage output port to 5 V.

It should be noted that, a specific implementation manner in the method procedure of S1 to S5 in the foregoing of the present disclosure is consistent with the description of the apparatus for quick charge, and is therefore no longer described herein.

As can be seen, in the method for supporting multi-battery quick charge provided in this embodiment of the present disclosure, on the basis of a normal charge chip for supporting multi-battery charge, an adapter, a voltage adjustment circuit and a processor are added, so that a voltage of a DP port and a voltage of a DM port on the adapter can be adjusted according to a voltage required for quick charge, and a voltage of a charge voltage output port can be coordinately limited by using the voltage of the DP port and the voltage of the DM port, to enable a charge voltage of an electronic device to change, according to a requirement, among four voltage values: 5 V, 9 V, 12 V and 20 V, thereby satisfying a requirement of multi-battery quick charge.

Various embodiments in the specification are described in a progressive manner. The same or similar parts between the embodiments may be referenced to each other. In each embodiment, the portion that is different from other embodiments is concentrated and described. In particular, with respect to a system embodiment, since it is substantially similar to the method embodiment, brief description is given. The related portions may be referenced to the description of the portions in the method embodiment.

Finally, it should be noted that, the above descriptions of the embodiments of the present disclosure are provided for demonstration to persons skilled in the art, instead of exhaustively listing all the embodiments or limiting the present disclosure to a single disclosed embodiment. In view of the above, various replacements and variations to the present disclosure are apparent to persons skilled in the art. Therefore, although some alternative embodiments have been discussed in detail, other embodiments are apparent or can be readily derived by a person skilled in the art. The present disclosure is intended to cover all the replacements, modifications and variations to the present disclosure that have been discussed here as well as other embodiments consistent with the spirit and scope of the present disclosure.

A person skilled in the art shall understand that the embodiments may be described to illustrate methods, apparatuses (devices), or computer program products. Therefore, hardware embodiments, software embodiments, or hardware-plus-software embodiments may be used to illustrate the present disclosure. In addition, the present disclosure may further employ a computer program product which may be implemented by at least one computer readable storage medium with an executable program code stored thereon. The computer readable storage medium includes but not limited to a disk memory, a CD-ROM, and an optical memory.

The present invention is described based on the flowcharts and/or block diagrams of the method, apparatus (device), and computer program product. It should be understood that each process and/or block in the flowcharts and/or block diagrams, and any combination of the processes and/or blocks in the flowcharts and/or block diagrams may be implemented using computer program instructions. These computer program instructions may be issued to a computer, a dedicated computer, an embedded processor, or processors of other programmable data processing device to generate a machine, which enables the computer or the processors of other programmable data processing devices to execute the instructions to implement an apparatus for implementing specific ftmctions in at least one process in the flowcharts and/or at least one block in the block diagrams.

These computer program instructions may also be stored a computer readable memory capable of causing a computer or other programmable data processing devices to work in a specific mode, such that the instructions stored on the computer readable memory implement a product comprising an instruction apparatus, wherein the instruction apparatus implements specific functions in at least one process in the flowcharts and/or at least one block in the block diagrams.

These computer program instructions may also be stored on a computer or other programmable data processing devices, such that the computer or the other programmable data processing devices execute a series of operations or steps to implement processing of the computer. In this way, the instructions, when executed on the computer or the other programmable data processing devices, implement the specific functions in at least one process in the flowcharts and/or at least one block in the block diagrams.

Although specific embodiments of the present disclosure are described, once acquiring basic innovative concepts, a person skilled in the art may make other changes and modifications to these embodiments. Therefore, the appended claims intend to be explained to include specific embodiments and all changes and modifications that fall within scope of the present disclosure. Obviously, a person skilled in the art may make various modifications and variations to the present disclosure without departing from the spirit and scope of the present disclosure. In this way, if these modifications and variations to the present disclosure fall within the scope of claims of the present disclosure and equivalent technologies thereof, the present disclosure also intends to cover these modifications and variations.

What is claimed is:

1. A device for supporting multi-battery quick charge, the device comprising a processor, a charge chip, and a voltage adjustment circuit, wherein:
a first adjustment port and a second adjustment port are disposed on the processor;
the voltage adjustment circuit comprises a first adjustment branch and a second adjustment branch;
an end of the first adjustment branch is connected to the first adjustment port, and an end of the second adjustment branch is connected to the second adjustment port.

2. The device for supporting multi-battery quick charge according to claim 1, wherein the first adjustment branch comprises a first MOSFET and a first resistor, and a first port, a second port and a third port are disposed on the first MOSFET, wherein
the first port is connected to the first adjustment port, the second port is connected to an end of the first resistor, the third port is connected to a direct-current voltage, and the other end of the first resistor is grounded.

3. The device for supporting multi-battery quick charge according to claim 1, wherein the second adjustment branch comprises a second MOSFET and a second resistor, and a first port, a second port and a third port are disposed on the second MOSFET, wherein
the first port is connected to the second adjustment port, the second port is connected to an end of the second resistor, the third port is connected to a direct-current voltage, and the other end of the second resistor is grounded.

4. The device for supporting multi-battery quick charge according to claim 1, wherein the first adjustment port and the first adjustment port are both general-purpose input output (GPIO).

5. An apparatus for supporting multi-battery quick charge, the apparatus for supporting multi-battery quick charge comprising an adapter and the device for supporting multi-battery quick charge according to claim 1, wherein
the adapter comprises a DP port, a DM port, a charge voltage output port and a ground port; and
the charge voltage output port is connected to a charge chip, the first adjustment branch is respectively connected to the DP port and a first adjustment port, and the second adjustment branch is respectively connected to the DM port and a second adjustment port.

6. The apparatus for supporting multi-battery quick charge according to claim 5, wherein a voltage of the charge voltage output port is coordinately limited by a voltage of the DP port and a voltage of the DM port.

7. The apparatus for supporting multi-battery quick charge according to claim 6, wherein that a voltage of the charge voltage output port is coordinately limited by a voltage of the DP port and a voltage of the DM port specifically comprises that:
when the voltage of the DP port is 0.6 V and the voltage of the DM port is 0.6 V, the voltage of the charge voltage output port is 12 V;
when the voltage of the DP port is 3.3 V and the voltage of the DM port is 0.6 V, the voltage of the charge voltage output port is 9 V;
when the voltage of the DP port is 3.3 V and the voltage of the DM port is 3.3 V, the voltage of the charge voltage output port is 20 V; and
when the voltage of the DP port is 0.6 V and the DM port is grounded, the voltage of the charge voltage output port is 5 V.

8. The apparatus for supporting multi-battery quick charge according to claim 5, wherein an interface between the adapter and the device for supporting multi-battery quick charge is a type-C interface.

9. A method for supporting multi-battery quick charge, applied to a terminal, and comprising:
when a connection is established between an electronic device and an adapter, sending, by the electronic device, a quick charge confirmation signal to the adapter;
extracting, by the adapter from the quick charge confirmation signal, a charge voltage value required by the electronic device and returning a response signal to the electronic device;
adjusting, by using a voltage of a DP port and a voltage of a DM port on the adapter, a value of a voltage of a charge voltage output port on the adapter to the charge voltage value required by the electronic device;
continuously charging, by the adapter, the electronic device by using the charge voltage output port and detecting a storage level of the electronic device; and
when the detected storage level reaches a preset power level threshold, disconnecting, by the adapter, the electronic device.

10. The method for supporting multi-battery quick charge according to claim 9, wherein the adjusting, by using a voltage of a DP port and a voltage of a DM port on the adapter, a value of a voltage of a charge voltage output port on the adapter to the charge voltage value required by the electronic device specifically comprises:
delivering, by a processor, according to the charge voltage value required by the electronic device, a first voltage adjustment instruction to a first adjustment branch connected to the DP port, to make a value of the voltage of the DP port match the charge voltage value of the electronic device; and
delivering, by a processor according to the charge voltage value required by the electronic device, a second voltage adjustment instruction to a second adjustment branch connected to the DM port, to make a value of the voltage of the DM port match the charge voltage value of the electronic device.

11. The method for supporting multi-battery quick charge according to claim 10, wherein the processor delivers the first voltage adjustment instruction to a MOSFET in the first adjustment branch by using a first adjustment port and delivers the second voltage adjustment instruction to a MOSFET in the second adjustment branch by using a second adjustment port.

12. The method for supporting multi-battery quick charge according to claim 9, wherein the adjusting, by using a voltage of a DP port and a voltage of a DM port on the adapter, a value of a voltage of a charge voltage output port on the adapter to the charge voltage value required by the electronic device specifically comprises:
when the voltage of the DP port is 0.6 V and the voltage of the DM port is 0.6 V, adjusting the voltage of the charge voltage output port to 12 V;
when the voltage of the DP port is 3.3 V and the voltage of the DM port is 0.6 V, adjusting the voltage of the charge voltage output port to 9 V;
when the voltage of the DP port is 3.3 V and the voltage of the DM port is 3.3 V, adjusting the voltage of the charge voltage output port to 20 V; and
when the voltage of the DP port is 0.6 V and the DM port is grounded, adjusting the voltage of the charge voltage output port to 5 V.
